(19) United States
(12) Patent Application Publication
(10) Pub. No.: US 2013/0295978 A1
(43) Pub. Date: Nov. 7, 2013

(54) METHOD AND APPARATUS FOR SCHEDULING RADIO FREQUENCY RESOURCES IN A MULTIPLE-RADIO-STACKS CONTEXT

(71) Applicant: Jari Ruohonen, Tampere (FI)

(72) Inventor: Jari Ruohonen, Tampere (FI)

(73) Assignee: NOKIA CORPORATION, Espoo (FI)

(21) Appl. No.: 13/883,587

(22) PCT Filed: Nov. 5, 2010
(86) PCT No.: PCT/IB2010/055046

§ 371 Date: Jul. 24, 2013

(51) Int. Cl. H04W 72/04

(52) U.S. Cl. CPC H04W 72/04
USPC 455/509

(57) ABSTRACT

In accordance with an example embodiment of the present invention, a method is disclosed that comprises receiving a request with a priority for a radio frequency (RF) resource from one of a plurality of wireless radio stacks at a user equipment, the request having a time window and pre-reserving the RF resource for the received request if the time window of the received request is fixed and is not in a conflict with that of an existing pre-reserved request or the priority of the request is higher than that of the existing, conflicting pre-reserved request. The method also comprises reserving the RF resource for the received request if the time window of the received request is not in a conflict with that of a pre-reserved request from a different radio stack or the priority of the received request is higher than that of the conflicting pre-reserved request.

### TECHNICAL FIELD

The present application relates generally to an apparatus and a method for scheduling radio frequency resources in a multiple-radio-stacks context.

### BACKGROUND

A multiple radio-stack communication device supports simultaneous operations of two or more radio stacks within a user equipment (UE) that may be from the same or different network operators. It is not uncommon that new generation of user equipment supports multiple radio stacks that may be activated simultaneously to support multiple services on different radio technologies. For efficiency of operations, the multiple radio stacks may need to share the same radio frequency (RF) resource. Each of the multiple radio stacks may request a frequency resource for user service or for radio stack maintenance. Multiple radio stacks may generate resource requests simultaneously while the user equipment is in an idle mode, to perform tasks such as maintaining simultaneous connections with one or more networks. A radio stack may include radio technology specific hardware and protocol software to enable the user equipment to operate on one or more radio frequency bands.

### SUMMARY

Various aspects of the invention are set out in the claims.

In accordance with an example embodiment of the present invention, a method comprises receiving a request with a priority for a radio frequency (RF) resource from one of a plurality of wireless radio stacks at a user equipment, the request having a time window and pre-reserving the RF resource for the received request if the time window of the received request is fixed and is not in a conflict with that of an existing pre-reserved request or the priority of the request is higher than that of the existing, conflicting pre-reserved request. The method also comprises reserving the RF resource for the received request if the time window of the received request is not in a conflict with that of a pre-reserved request from a different radio stack or the priority of the received request is higher than that of the conflicting pre-reserved request.

In accordance with an example embodiment of the present invention, an apparatus comprises at least one processor, and at least one memory including computer program code. The at least one memory and the computer program code are configured to, with the at least one processor, cause the apparatus to receive a request with a priority for a radio frequency (RF) resource from one of a plurality of wireless radio stacks at a user equipment, the request having a time window; to pre-reserve the RF resource for the received request if the time window of the received request is fixed and it is not in a conflict with that of an existing pre-reserved request or the priority of the request is higher than that of the existing, conflicting pre-reserved request; and reserving the RF resource for the received request if the time window of the received request is not in a conflict with that of a pre-reserved request from a different radio stack or the priority of the received request is higher than that of the conflicting pre-reserved request.

In accordance with another example embodiment of the present invention, a computer program product comprises a computer-readable medium bearing computer program code embodied therein for use with a computer. The computer program code comprises code for receiving a request with a priority for a radio frequency (RF) resource from one of a plurality of wireless radio stacks at a user equipment, the request having a time window and the code for pre-reserving the RF resource for the received request if the time window of the received request is fixed and it is not in a conflict with that of an existing pre-reserved request or the priority of the request is higher than that of the existing, conflicting pre-reserved request. The computer program code also comprises code for reserving the RF resource for the received request if the time window of the received request is not in a conflict with that of a pre-reserved request from a different radio stack or the priority of the received request is higher than that of the conflicting pre-reserved request.

### BRIEF DESCRIPTION OF DRAWINGS

For a more complete understanding of example embodiments of the present invention, reference is now made to the following descriptions taken in connection with the accompanying drawings in which:

FIG. 1 illustrates an example wireless system in accordance with an example embodiment of the invention;

FIG. 2 illustrates an example method for scheduling RF resources in accordance with an example embodiment of the invention;

FIG. 3 illustrates example multiple radio stacks within a user equipment in accordance with an example embodiment of the invention; and

FIG. 4 illustrates an example wireless apparatus in accordance with an example embodiment of the invention.

### DETAILED DESCRIPTION

Disclosed herein is a scheduling apparatus and method which feature a pre-reservation step to screen and order the RF resource requests based on a time window and a priority of a request before the RF resource is reserved. The time window can be flexible or fixed and the priority of a request can be adjusted if the request is rejected due to a conflict with another request.

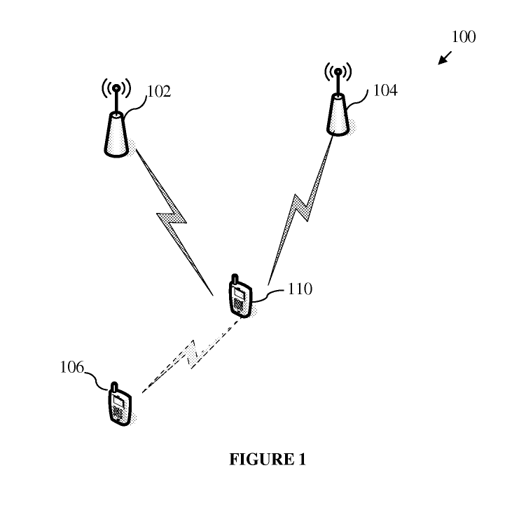

An example embodiment of the present invention and its potential advantages are best understood by referring to FIGS. 1 through 4 of the drawings, like numerals being used for like and corresponding parts of the various drawings.

FIG. 1 illustrates an example wireless system 100 in accordance with an example embodiment of the invention. The wireless system 100 includes a base station 102 of a wideband code division multiple access (WCDMA) network, a base station 104 of a long-term evolution (LTE) network, a first user equipment 110 and a second user equipment (UE) 106. In one example embodiment, the UE 110 is connected to the WCDMA base station 102 and the LTE base station eNodeB 104 at the same time. In addition, the UEs 110 and 106 are also connected to each other via a different radio technology such as a device-to-device (D2D) wireless connection.

In one example embodiment, when the UE 110 has three radio stacks activated to maintain three wireless connections simultaneously, via a LTE connection to the base station 104, a WCDMA connection to the base station 102, and a D2D connection to the UE 106. Three radio stacks within the UE 110 are activated simultaneously and each radio stack may generate radio resource requests to maintain the respective connection and other radio protocol related operations, in addition to resource requests related to the user traffic such as beaconing, while the UE is in an idle state. The UE 110 may pre-reserve the RF resource for the received request if the time window of the received request is fixed with at least a fixed start time and there is not any schedule conflict with another pre-reserved request. The UE 110 may reserve the RF resource for a pre-reserved request by granting the resource to the request if the request is not preempted by another request with a higher priority. If the attempt to pre-reserve the RF resource for the request is not successful, its priority is raised and the likelihood for the request to be served the next time is increased. As such, the UE 110 may maintain multiple radio connections while ensuring that each request from a radio stack is served depending on its priority and time window. In an alternative embodiment, the base station 102 may be a wireless local area network (WLAN) access point, a Time Division Synchronous Code Division Multiple Access (TD-SCDMA) base station, or a cell broadcast base station or a GSM base station.

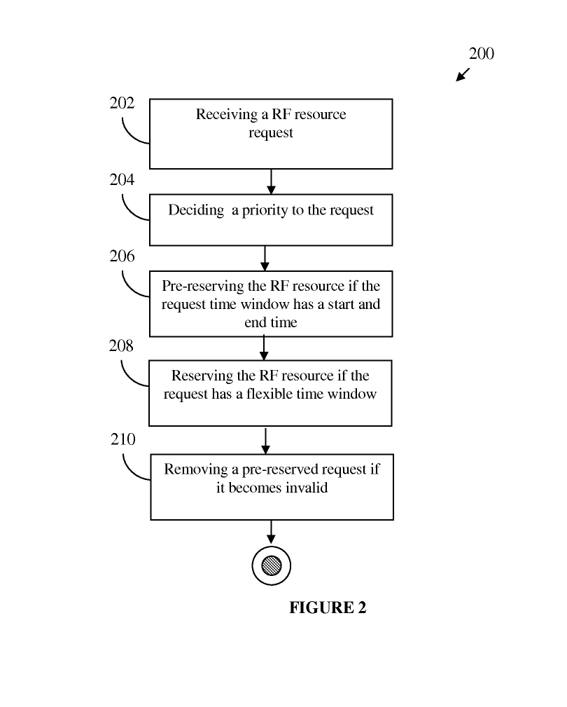

FIG. 2 illustrates an example method 200 for scheduling radio resources in a multiple radio-stack context in accordance with an example embodiment of the invention. The method 200 includes receiving a RF resource request at block 202, deciding a priority for the received request at block 204, and pre-reserving the RF resource if the request time window is fixed at block 206. The method 200 also includes reserving the RF resource if the request has a flexible time window at block 208, and removing a pre-reserved request if it becomes invalid at block 210.

In one example embodiment, receiving a RF resource request at block 202 may include receiving at a user equipment a request with a priority for radio frequency resource from one of a plurality of wireless radio stacks at a user equipment. This is an internal request that is generated from the radio stack within the UE. A request may also come from an external source such as a base station. The request has a time window that is either fixed or flexible. The time window is fixed if it has at least a fixed start time. It may also have a fixed end time but the request may be completed earlier than the fixed end time. Furthermore, receiving a RF resource request at block 202 may include receiving the request from a user equipment, a reservation waiting queue containing one or more previous unscheduled requests. There could be reservations from several radio stacks in the queue. A radio stack may schedule routine, repetitive operations to maintain the connection with the network and perform radio protocol maintenance related tasks. One example of such radio protocol maintenance operations is periodic measurements of radio signals at a given frequency. The user equipment may be in an idle state or an active state and generally speaking it is in an idle state when the maintenance operations are performed for the multiple radio stacks. In one example embodiment, a UE may also maintain these measurements in an active state. In a multiple-radio stack mode, when one radio stack is in an active mode, the other radio stack may be allowed to lose service.

The time window of the RF resource request is flexible if it has a fixed duration without a fixed start time and a fixed end time. A flexible-window request may complete earlier than the allocated duration. A time domain of the time window is common to all radio stacks and is based on a synchronized, common shared hardware timer. In an alternative embodiment, each radio stack has its own timers and all the timers are synchronized. In another embodiment, the multiple radio stacks share more than one RF resources. In yet another embodiment, receiving the request at block 202 includes receiving the request for more than one RF resources from at least one radio stack.

In one example embodiment, receiving a request at block 202 may take place at a time when a radio stack identifies its needs to use the RF resource. The radio stack may calculate beforehand these times in future when it would need the RF resources. In some cases, it may not calculate the times too far in the future because the UE may move to a different location and execute a cell re-selection or changing radio conditions might trigger needs for fresh reception of radio signals.

In one example embodiment of a 3GPP compliant network, upon completion of cell selection and when a cell reselection is initiated, the UE is to synchronize with and read the broadcast control channel (BCCH) information for 6 strongest non-serving carriers at a base station. BCCH information messages of GSM multiframe are sent as a screening indicator periodically; if some screening indicator is not received due to a conflict with another request with a higher priority, this SI message is assigned a higher priority for the next period to increase its chance of obtaining the needed RF resource. In another example embodiment, the UE may decode the BCCH data block that contains the parameters affecting cell reselection for each of the 6 strongest non-serving cell BCCH carriers at least every 5 minutes. The UE may attempt to decode the full BCCH data of the serving cell at least every 30 seconds. The corresponding radio stack may generate requests for RF resources on a regular basis for the repeated operations. In another example embodiment, the BCCH carriers have constant power all the time and the UE may perform power monitoring at any moment of time. For this task, a flexible time window rather than a fixed one is more suitable.

In one example embodiment, deciding a priority for the received request at block 204 may include deciding the priority for the request based at least on one of the following: the type of a traffic load, the current radio conditions, and a user preference. For example, the user may set priority of one type of traffic load higher based on a user need or preference. In one example embodiment, deciding the priority for the request may also include assigning priorities in a descending order to following traffic data types: paging, system information reception for cell re-selection, signaling channel (SCH) reception for cell re-selection, cell screening indicator (SI) refresh by cell broadcast channel (CBCH) reception, and public land mobile network (PLMN) search SI/SCH reception, and traffic data with a flexible window. In one example embodiment, a paging signal has the highest priority because it indicates a user's attempt to establish a connection and user data in general has higher priority over the data for radio stack maintenance that may tolerate rejection of a RF resource request better.

In one example embodiment, deciding the priority for the received request at block 204 may further include deciding the priorities according to one of priority schemes, which can be a user configurable priority scheme, a default priority scheme and a priority scheme on a per radio stack basis with a symmetric or asymmetric configuration. There may also be a maximum priority value per operation type and the maximum priority value could be different from one radio stack to another radio stack. The different options for selecting the rules of the priority scheme allow implementation of a symmetric configuration where each radio stack has equal priority over the RF or an asymmetric configuration where some radio stack has higher priorities than others.

In one example embodiment, deciding the priority for the request at block 204 may further include assigning a higher priority to the request if it is a resubmitted request that failed to obtain a requested resource due to its priority being lower than that of a conflicting pre-reserved request. In some example embodiments, the conflicts may often be resolved in a scheduler during the pre-reservation phase. In this case the radio stack is informed of the conflict resolution when the radio stack attempts to perform the actual RF reservation. In some other example embodiment, the conflict can also happen with an ongoing reservation and there is a possibility that pre-reservation phase may be skipped during an ongoing reserved window. The step size to increase the priority may not be fixed to a value such as 1 and may change in a dynamic or non-linear way depending on the number of pre-reservation attempts a request has been denied previously.

In one example embodiment, pre-reserving the RF resource at block 206 may include admitting the request into a reservation queue without allocating the RF resource. In one example embodiment, pre-reserving the RF resource at block 206 may include bypassing pre-reserving the RF resource and directly scheduling the RF resource for the received request if the request is urgent. For example, the bypassing of pre-reserving the RF resource may happen due to changing radio conditions when there is a new target for SCH reception (Rx) or SI Rx and the Rx timings is not available beforehand. The request may be urgent if its priority is high, the fixed time window of the request is imminently due or a user defined condition is met. Pre-reserving the RF resource at block 206 may also include raising the priority of the request and placing the request in a reservation waiting queue of a scheduler if the priority of the request is lower than or equal to that of the conflicting pre-reservation. The pre-reservation is used with fixed time windows in general, because there is little benefit to make pre-reservation for requests with flexible time windows since the scheduler may simply find a next available time window for a flexible time window request.

In one example embodiment, pre-reserving the RF resource for the request at block 206 further comprises one of the following actions if the priority of the request is lower than or equal to that of the conflicting pre-reservation or if the priority of the request is lower than or equal to that of the conflicting pre-reservation and the type of request is not a flexible time window. One action is raising the priority of the request, calculating a new time window for the request with the raised priority, and placing the request in a reservation waiting queue of a scheduler. An alternative action is placing the request in the reservation queue of the scheduler or rejecting the received request so that the radio stack may resubmit the request in a subsequent time period.

In one example embodiment, reserving the RF resource at block 208 may include reserving the RF resource for the received request if the time window of the received request is not in a conflict with that of a pre-reserved request from a different radio stack or the priority of the received request is higher than that of the conflicting pre-reserved request. Reserving the RF resource at block 208 may also include scheduling the RF resource in the available time window and granting access to the RF resource in a next available time window that is at least as large as the duration of the time window of the request.

In one example embodiment, reserving the RF resource for the request at block 208 may also include at least one of following operations: placing the request in a reservation waiting queue of a scheduler if the priority of the request is lower than or equal to that of the conflicting pre-reservation; and scheduling a next available time window of the RF resource for the request if the priority of the request is lower than or equal to that of an existing pre-reservation. In one example embodiment, removing a pre-reserved request if it becomes invalid at block 210 may include removing a pre-reserved request from a reservation waiting queue if a time window of the pre-reserved request becomes invalid. For example, the time window becomes invalid if it has a hard real-time start time and end time which cannot be met any more. A radio stack might also request a removal of a time window when the requested SI could be decoded correctly from partial received information. For example, the first 2 to 3 bursts of a 4 burst blocks may be used to decode the entire block based on an agreed-upon convolutional decoding including redundancy. In another example embodiment, a cell re-selection may change periodical receiving needs, thus making some of received information invalid when cell re-selection criteria are met and thus there is a need to remove a previously scheduled time window.

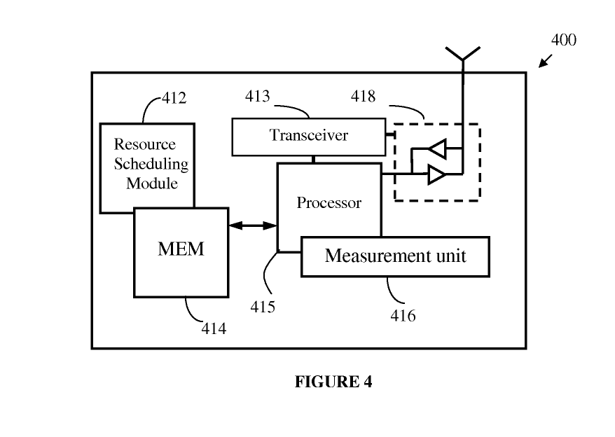

In one example embodiment, the method 200 may be implemented at the UE 110 of FIG. 1 or at the apparatus 400 of FIG. 4. The method 200 is for illustration only and the steps of the method 200 may be combined, divided, or executed in a different order than illustrated, without departing from the scope of the invention of this example embodiment.

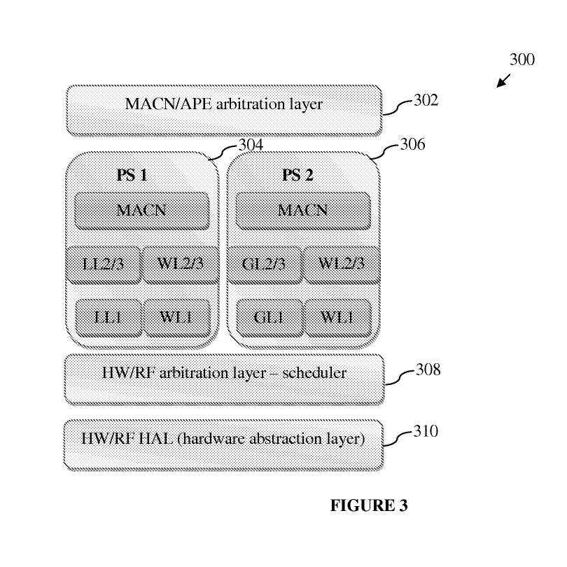

FIG. 3 illustrates example multiple radio stacks 300 in accordance with an example embodiment of the invention. The multiple radio stacks 300 may include a multi-access core network (MACN) and application engine (APE) arbitration layer 302, two radio protocol stacks 304 and 306, a hardware/radio frequency arbitration layer 308 and a hardware for radio frequency abstraction layer (HAL) 310. The MACN arbitration layer 302 may be configured to mediate differences between different access network technologies. The radio protocol stack (PS) 304 and the PS 306 are configured to support two different radio stack and radio protocols. The PS 304 includes MACN functionalities at network layer, a LTE layer 2 and 3 (LL2/3) protocol support functionality and LTE layer 1 (LL1) support functionalities. The PS 304 also includes a WCDMA layer 2/3 (WL2/3) support function, and a WCDMA layer 1 (WL1) support function. The protocol stack 306 is configured to support the two radio stacks, WCDMA and Global System for Mobile communications (GSM), and may have the two radio stacks activated at the same time. The PS 306 includes MACN support functionality at network layer, a WCDMA layer 2/3 (WL2/3) support functionality in parallel to a GSM layer 2/3 (GL2/3) support functionality, and a WCDMA layer 1 (WL1) support functionality in parallel to a GSM layer 1 (GL1) support function. The hardware and radio frequency arbitration layer 308 may be configured to mediate differences between radio stacks at hardware and radio frequency layer. The hardware and radio frequency arbitration layer 308 may also implement a scheduler with the method 200 illustrated in FIG. 2 and described above. The hardware and radio frequency abstraction layer 310 may be configured to represent the radio hardware in an abstraction. In one example embodiment, the two radio stacks, the GSM radio stack and WCDMA radio stack or the WCDMA radio stack and the LTE radio stack are activated simultaneously. The activated radio stacks may request resources simultaneously to perform tasks such measurements and protocol maintenances. The users of the WCDMA, LTE and GSM services may also request services at any time and a request for user traffic in general has a higher priority over the request from the radio stacks.

FIG. 4 illustrates an example wireless apparatus in accordance with an example embodiment of the invention. In FIG. 4, the wireless apparatus 400 may include a processor 415, a memory 414 coupled to the processor 415, and a suitable transceiver 413 (having a transmitter (TX) and a receiver (RX)) coupled to the processor 415, coupled to an antenna unit 418. The memory 414 may store programs such as a resource scheduling module 412. The wireless apparatus 400 may be at least part of a generic 4^{th} generation base station, or an LTE compatible base station.

The processor 415 or some other form of generic central processing unit (CPU) or special-purpose processor such as digital signal processor (DSP), may operate to control the various components of the wireless apparatus 400 in accordance with embedded software or firmware stored in memory 414 or stored in memory contained within the processor 415 itself. In addition to the embedded software or firmware, the processor 415 may execute other applications or application modules stored in the memory 414 or made available via wireless network communications. The application software may comprise a compiled set of machine-readable instructions that configures the processor 415 to provide the desired functionality, or the application software may be high-level software instructions to be processed by an interpreter or compiler to indirectly configure the processor 415.

In an example embodiment, the resource scheduling module 412 may be configured to receive a request with a priority for radio frequency (RF) resource for a traffic load from one of a plurality of radio stacks, the request having a time window that is either fixed or flexible. The resource scheduling module 412 is also configured to decide the priority for the received request according to one of a user configurable priority scheme, a default priority scheme and a priority scheme on a per radio stack basis with a symmetric or asymmetric configuration. In an alternative embodiment, the resource scheduling module may delegate the responsibility of deciding the priority to a radio stack so that the resource scheduling module may be generic in nature and configured to accommodate multiple radio stacks. The resource scheduling module 412 is also configured to pre-reserve the RF resource for the received request if the time window of the received request is fixed and it is not in a conflict with that of an existing pre-reserved request or the priority of the request is higher than that of an existing, conflicting pre-reserved request. The resource scheduling module 412 is also configured to reserve the RF resource for the received request if the time window of the received request is not in a conflict with that of a pre-reserved request from a different radio stack or the priority of the received request is higher than that of the conflicting pre-reserved request. In another embodiment, the multiple radio stacks may share more than one RF resource.

In one example embodiment, the transceiver 413 is for bidirectional wireless communications with another wireless device. The transceiver 413 may provide frequency shifting, converting received RF signals to baseband and converting baseband transmit signals to RF, for example. In some descriptions a radio transceiver or RF transceiver may be understood to include other signal processing functionality such as modulation/demodulation, coding/decoding, interleaving/deinterleaving, spreading/despreading, inverse fast fourier transforming (IFFT)/fast fourier transforming (FFT), cyclic prefix appending/removal, and other signal processing functions. In some embodiments, the transceiver 413, portions of the antenna unit 418, and an analog baseband processing unit may be combined in one or more processing units and/or application specific integrated circuits (ASICs). Parts of the transceiver may be implemented in a field-programmable gate array (FPGA) or reprogrammable software-defined radio.

In an example embodiment, the antenna unit 418 may be provided to convert between wireless signals and electrical signals, enabling the wireless apparatus 400 to send and receive information from a cellular network or some other available wireless communications network or from a peer wireless device. In an embodiment, the antenna unit 418 may include multiple antennas to support beam forming and/or multiple input multiple output (MIMO) operations. As is known to those skilled in the art, MIMO operations may provide spatial diversity and multiple parallel channels which can be used to overcome difficult channel conditions and/or increase channel throughput. The antenna unit 418 may include antenna tuning and/or impedance matching components, RF power amplifiers, and/or low noise amplifiers.

As shown in FIG. 4, the wireless apparatus 400 may further include a measurement unit 416, which measures the signal strength level that is received from another wireless device, and compare the measurements with a configured threshold. The measurement unit may be utilized by the wireless apparatus 400 in conjunction with various exemplary embodiments of the invention, as described herein.

In general, the various exemplary embodiments of the wireless apparatus 400 may include, but are not limited to, part of a mobile station, an access point or a wireless device such as a portable computer having wireless communication capabilities, Internet appliances permitting wireless Internet access and browsing, as well as portable units or terminals that incorporate combinations of such functions. In one embodiment, the wireless apparatus 400 may be implemented in the network node 110 of FIG. 1.

Without in any way limiting the scope, interpretation, or application of the claims appearing below, a technical effect of one or more of the example embodiments disclosed herein is to guarantee that the highest priority RF requests get RF resource as often as possible in practice and in general that all requests get RF time eventually while the wait time may be longer for less important or less urgent requests. Another technical effect of one or more of the example embodiments disclosed herein is to help minimize software changes needed for transitioning from a single radio stack system to a multiple radio-stack system because the requests for the RF resource for both systems are the same, both based on the priority scheme as described herein. Yet another technical effect of one or more of the example embodiments disclosed herein is to avoid the need for special control for many situations where the requested RF resources are not granted to the request due to lower priority of the request. Yet another technical effect of one or more of the example embodiments disclosed herein is that the maintenance of the software and addition of new features are simplified because the requests from a single radio stack and multiple radio stacks within a UE are treated in a similar manner.

Embodiments of the present invention may be implemented in software, hardware, application logic or a combination of software, hardware and application logic. The software, application logic and/or hardware may reside on a mobile station, an access point, a user equipment or similar network device. If desired, part of the software, application logic and/or hardware may reside on access point, and part of the software, application logic and/or hardware may reside on a network element such as a base station. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 4. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims

1. A method, comprising:
receiving a request with a priority for a radio frequency (RF) resource at a user equipment from one of a plurality of wireless radio stacks at the user equipment, the request having a time window;
pre-reserving the RF resource at the user equipment for the received request if the time window of the received request is fixed and is not in a conflict with that of an existing pre-reserved request or the priority of the request is higher than that of the existing, conflicting pre-reserved request; and
reserving at the user equipment the RF resource for the received request if the time window of the received request is not in a conflict with that of a pre-reserved request from a different radio stack or the priority of the received request is higher than that of the conflicting pre-reserved request.

2. The method of claim 1, wherein the time window is fixed or flexible, and wherein the time window is fixed if it has at least a fixed start time, and the time window is flexible if it has a fixed duration without a fixed start time and a fixed end time and wherein a time domain of the time window is common to the plurality of radio stacks and based on a synchronized hardware timer.

3. The method of claim 1, wherein receiving the request further comprises at least one of:
receiving the request for more than one RF resources; and
receiving the request from a source, said source including one of a user equipment, a network, a reservation waiting queue including one or more unscheduled requests, and a scheduled repetitive operation.

4. The method of claim 1, wherein pre-reserving the RF resource for the request further comprises:
placing the request in a reservation waiting queue of a scheduler without allocating the RF resource.

5. The method of claim 1, wherein pre-reserving the RF resource further comprises bypassing pre-reserving the RF resource and directly scheduling the RF resource for the request if the request is urgent based on one of the priority of the request being high, the time window of the request being imminent and a user defined condition being met.

6. The method of claim 1 wherein pre-reserving the RF resource for the request further comprises, if the priority of the request is lower than or equal to that of the conflicting pre-reservation or if the priority of the request is lower than or equal to that of the conflicting pre-reservation and the request has a fixed time window, one of:
rejecting the request so that the radio stack resubmit the request in a subsequent time period;
raising the priority of the request, calculating a new time window for the request with the raised priority, and placing the request in a reservation waiting queue of a scheduler; and
placing the request in the reservation queue of the scheduler.

7. The method of claim 1, wherein reserving the RF resource for the request with a fixed time window comprises one of:
rejecting the request if the time window is in conflict with an existing request with a higher priority and placing the request in a waiting queue; and
granting the RF resource to the request if a conflict with the existing request is resolved while pre-reserving the RF resource.

8. The method of claim 1, wherein reserving the RF resource in the available time window further comprises:
granting access to the RF resource in a next available time window that is at least as large as the duration of the time window of the request if the request has a flexible time window.

9. The method of claim 1, wherein reserving the RF resource for the request further comprises, if the request has a flexible time window at least one of:
granting the RF resource if the time window of the request is not in any conflict with an existing reservation;
placing the request in a reservation waiting queue of a scheduler if the priority of the request is lower than or equal to that of the conflicting pre-reservation; and
scheduling a next available time window of the RF resource for the request if the priority of the request is lower than or equal to that of an existing pre-reservation.

10.-15. (canceled)

16. An apparatus, comprising:
at least one processor; and
at least one memory including computer program code,
the at least one memory and the computer program code configured to, with the at least one processor, cause the apparatus to perform:
receiving a request with a priority for a radio frequency (RF) resource from one of a plurality of wireless radio stacks, the request having a time window;
pre-reserving the RF resource for the received request if the time window of the received request is fixed and it is not in a conflict with that of an existing pre-reserved request or the priority of the request is higher than that of the existing, conflicting pre-reserved request; and
reserving the RF resource for the received request if the time window of the received request is not in a conflict with that of a pre-reserved request from a different radio stack or the priority of the received request is higher than that of the conflicting pre-reserved request.

17. The apparatus of claim 16, wherein the time window is fixed or flexible, and wherein the time window is fixed if it has at least a fixed start time, and the time window is flexible if it has a fixed duration without a fixed start time and end time and wherein a time domain of the time window is common to the plurality of radio stacks and based on a synchronized hardware timer.

18. The apparatus of claim 16, wherein the at least one memory and the computer program code are configured to, with the at least one processor, cause the apparatus to receive the request a source, the source comprising
one of a user equipment, a network, a reservation waiting queue including one or more unscheduled request, and a scheduled repetitive operation.

19. The apparatus of claim 16, wherein the at least one memory and the computer program code are further configured to, with the at least one processor, cause the apparatus to perform at least one of:
placing the request in a reservation waiting queue of a scheduler without allocating the RF resource; and
bypassing pre-serving the RF resource and directly scheduling the RF resource for the request if the request is urgent based on one of the priority of the request being high, the fixed time window of the request being imminent and a user defined condition being met

20. The apparatus of claim 16, wherein the at least one memory and the computer program code are further configured to, with the at least one processor, cause the apparatus to reserve the RF resource for the available time window by performing at least one of:
granting access to the RF resource in a next available time window that is at least as large as the duration of the time window of the request if the request has a flexible time window;
placing the request in a reservation waiting queue of a scheduler if the priority of the request is lower than or equal to that of the conflicting pre-reservation if the received request has a flexible time window; and
scheduling a next available time window of the RF resource for the request if the priority of the request is lower than or equal to that of an existing pre-reservation and the request has a flexible time window.

21. The apparatus of claim 16, wherein the at least one memory and the computer program code are further configured to, with the at least one processor, cause the apparatus to decide the priority for the request based on at least one of a type of a traffic load, a current traffic condition, and a user preference by performing one of:
raising the priority of the request if the request is a resubmitted request that failed to obtain a requested resource due to its priority being lower than that of a conflicting pre-reservation and calculating a new time window for the request with the raised priority;
assigning priorities in a descending order to following traffic data types: a paging, system information reception for cell re-selection, a signaling channel (SCH) reception for cell re-selection, a cell screening indicator (SI) refresh by broadcast control channel (CBCH) reception, a public land mobile network (PLMN) search SI/SCH Rx, and traffic data with a flexible window; and
assigning the priorities according to one of a user configurable priority scheme, a default priority scheme and a priority scheme on a per radio stack basis with a symmetric or asymmetric configuration.

22. The apparatus of claim 16, wherein the time window is fixed or flexible, the time window being fixed if it has at least a fixed start time, and the time window being flexible if it has a fixed duration without a fixed start time and end time, and wherein a time domain of the time window is common to the plurality of radio stacks and based on a synchronized hardware timer.

23. The apparatus of claim 16, wherein the plurality of wireless radio stacks share a same set of RF resources with different timings within the apparatus and the plurality of radio stacks include GSM, wideband code division multiple access (WCDMA) and long-term evolution (LTE) radio stacks and the apparatus is in one of an idle state and an active state.

24. The apparatus of claim 16, wherein the at least one memory and the computer program code are further configured to, with the at least one processor, cause the apparatus to schedule a semi-hard time for an application which is tolerable to longer delay in receiving resource grant and has a hard start time and end time.

25. The apparatus of claim 16, wherein the plurality of wireless radio stacks share more than one RF resource.

26. A computer program product comprising a non-transitory computer-readable medium bearing computer program code embodied therein for use with a computer, the computer program code comprising:
code for receiving a request with a priority for a radio frequency (RF) resource at a user equipment from one of a plurality of wireless radio stacks at the user equipment, the request having a time window;
code for pre-reserving the RF resource at the user equipment for the received request if the time window of the received request is fixed and it is not in a conflict with that of an existing pre-reserved request or the priority of the request is higher than that of the existing, conflicting pre-reserved request; and
code for reserving at the user equipment the RF resource for the received request if the time window of the received request is not in a conflict with that of a pre-reserved request from a different radio stack or the priority of the received request is higher than that of the conflicting pre-reserved request.

27. (canceled)
